(19) United States
(12) Patent Application Publication
(10) Pub. No.: US 2007/0265661 A1
(43) Pub. Date: Nov. 15, 2007

(54) Musical pacifier

(76) Inventor: Christopher T. Coleman, Hastings, FL (US)

Correspondence Address: Christopher T. Coleman, P.O. Box 117, Hastings, FL, 32145, US

(21) Appl. No.: 11/431,866

(22) Filed: May 11, 2006

(51) Int. Cl. A61J 17/00

(52) U.S. Cl. 606/234

(57) ABSTRACT

This pacifier combines the ability to provide a scent for the nipple and or educational material for the child while the pacifier is being used.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

A. Field of the Invention

This relates to pacifiers in general for toddlers or infants. Pacifiers are typically used to sooth the child.

This invention combines the function of a pacifier with a musical tone as well as a voice message to encourage learning. Additionally, it will be flavored.

B. Prior Art

There are many other prior art patent references concerning pacifiers in general. A few examples of this are Baer U.S. Pat. No. 4,192,307, Shrock U.S. Pat. No. 5,772,684 and Shorey U.S. Pat. No. 4,992,283.

The Baer patent is a pacifier with a sweets dispensing nipple. In the current application there will also be a sweets dispensing nipple or a flavored nipple. Baer does not teach musical pacifier or an educational type pacifier.

Shrock is a musical pacifier but the nipple is not flavored and one is not made obvious by the application.

Shorey is a frozen confection holder for a toddler. This is somewhat different than the current application.

The current application combines both the sweets dispensing nipple, a musical pacifier, and a voice pacifier for learning purposes. The structure of the present application is also completely different from the previously referenced patents.

### BRIEF SUMMARY OF THE INVENTION

This is a baby pacifier. It will have the general shape of a baby nipple and will also have a specifically designed container into which the nipple will fit.

A flavor on the pacifier nipple will be used. Examples of the flavors would include, strawberry, apple or grape flavor, as examples. In addition to a flavored nipple the device will also be equipped with a memory chip which can play music or educational material, such as ABC's or 123's to a child while the child is using the pacifier. A power source and the necessary electrical connections would be included as well as a small speaker for sound. A way to access and change the chip and battery would also be provided.

### BRIEF DESCRIPTION OF THE DRAWINGS

FIG. 1 is a isometric perspective view of the pacifier and dispenser.

FIG. 2 is a side view of the pacifier.

FIG. 3 is a cross sectional view of the pacifier.

FIG. 4 is an enlarged view of the means of access.

FIG. 5 is a view of the container or dispenser.

### DETAILED DESCRIPTION OF THE EMBODIMENT

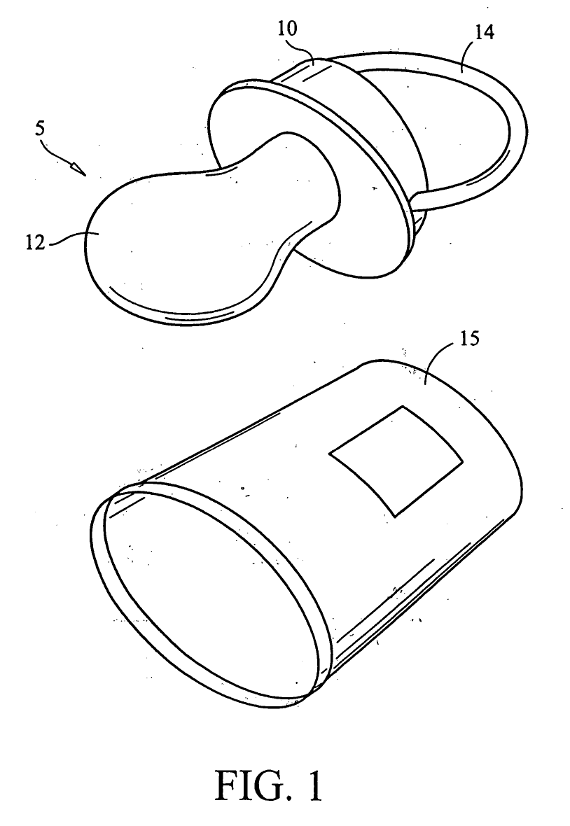

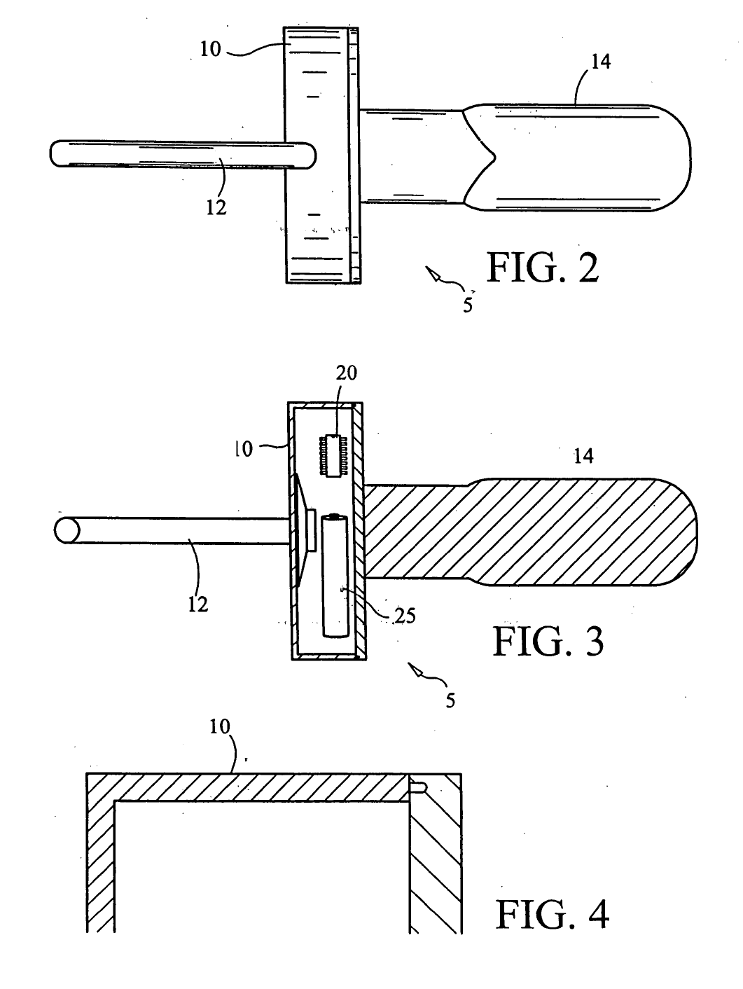

The device 5 is a pacifier for an infant. It will have the general shape of a pacifier which will include a nipple 12, a ring 14, a cavity 10 as well as a dispenser 15. FIG. 1 The dispenser 15 would house the pacifier when it is not in use to prevent foreign material and bacteria from collecting on the pacifier 5.

Within the cavity 10 will be housed a power source 25, a computer chip 20 and a speaker 30. Appropriate electrical connections will be installed as well to connect the power source 25 with the computer chip 20 and the speaker 30. It is likely that the power source will be a battery or series of batteries. This device is designed so that the chip 20 is interchangeable and replaceable. The chip 20 may play music, or may play educational material or may play something predetermined by the user or owner of the device.

A means of access to open the cavity 10 will also be provided. It is likely to be a snap mechanism with a prong on one part of the side of the cavity with the appropriate interlocking groove on the other such as depicted in FIG. 4. The means of access may also include a button and snap or may be a hook and loop assembly to open and close the cavity.

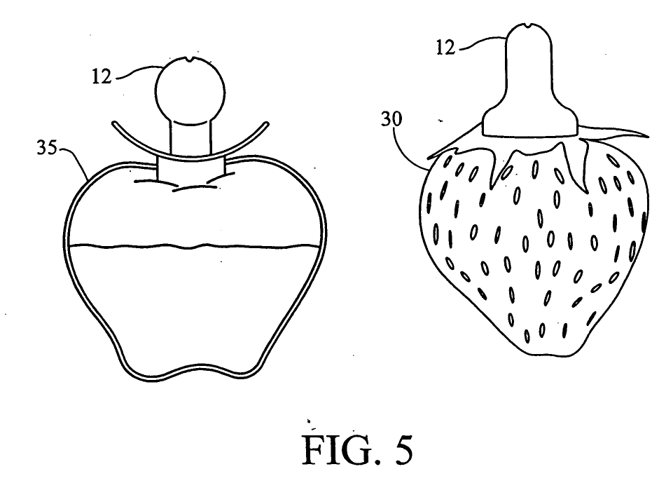

It is anticipated that in addition the nipple 12 will be flavored and that the dispensing container 35 such as shown in FIG. 5 may be a different type of fruit to provide the appropriate smell or flavor for the pacifier.

While the embodiments of the invention have been disclosed, certain modifications may be made by those skilled in the art to modify the invention without departing from the spirit of the invention.

The inventor claims:

1. A pacifier for an infant which is comprised of:
a. nipple;
wherein the nipple is connected to the front plate of the device;
b. ring;
wherein a ring is provided to hold the pacifier and is connected to the cavity of the device;
c. cavity;
wherein the cavity contains the power source;
wherein the cavity contains the speaker;
wherein the cavity contains a computer chip;
wherein appropriate electrical connections are provided in the cavity to provide the necessary power for the device;
wherein a means to access the cavity is provided.

2. The power source as described in claim 1 is a battery.

3. The power source as described in claim 1 is a plurality of batteries.

4. The computer chip as described in claim 1 provides musical entertainment.

5. The computer chip as described in claim 1 provides educational voice material for the child.

6. The means of access as described in claim 1 is a button and snap device.

7. The means of access as described in claim 1 is a hook and loop assembly.

8. The means of access as described in claim 1 is a prong with a corresponding indentation in one of the surfaces of the cavity.

9. The nipple as described in claim 1 is flavored.

10. The dispenser as described in claim 1 provides the scent or flavor to be applied to the pacifier.
